(19) United States
(12) Patent Application Publication
(10) Pub. No.: US 2015/0000815 A1
(43) Pub. Date: Jan. 1, 2015

(54) Pneumatic Tire

(71) Applicant: The Yokohama Rubber Co., Ltd., Tokyo (JP)

(72) Inventor: Takahiro Yamakawa, Hiratsuka-shi (JP)

(21) Appl. No.: 14/371,805

(22) PCT Filed: Jan. 11, 2013
(86) PCT No.: PCT/JP2013/050371

§ 371 Date: Jul. 11, 2014

(30) Foreign Application Priority Data
Jan. 11, 2012 (JP) 2012-002874

(51) Int. Cl. B60C 13/00

(52) U.S. Cl. CPC B60C 13/001
USPC 152/524

(57) ABSTRACT

The side wall portion of this pneumatic tire has a pattern visibly distinguished from the surrounding region. The pattern has: a first pattern element region at which are formed a pair of first reduced regions, which are provided on a line linking a pair of corners in a first demarcated section containing a pair of corners that are opposite each other, and a first primary region, which is visibly distinguished from the first reduced regions; and a second pattern element region at which are formed a pair of second reduced regions, which have the same unevenness or light reflection characteristics as the first primary region and are provided on a line linking a pair of corners in a second demarcated section containing a pair of corners that are opposite each other, and a second primary region, which has the same unevenness or light reflection characteristics as the first reduced region.

### TECHNICAL FIELD

The present technology relates to a pneumatic tire having a pattern on a side wall portion.

### BACKGROUND

In recent years, the side wall thickness (hereinafter, also referred to as the side gauge) of pneumatic tires has been made thinner in order to achieve reduction in weight and low rolling resistance. However, if the side gauge is made thin, appearance flaws tend to occur at high probability on the side wall surfaces. These appearance flaws do not have any adverse effect on the tire durability or driving performance, but users are concerned whether these flaws might indicate low tire durability or driving performance.

Specifically, in the molding process during tire manufacture, the sheet-like carcass member is wound once around the tire forming drum, and the winding starting end and the winding finishing end are partially overlapped to form a joint. Therefore, the thickness of the overlapping portion is greater, and this portion appears as undulation on the side wall surface on the finished tire. In particular, in radial tires that use one carcass member, this undulation is very pronounced.

On the other hand, a pneumatic tire in which the undulation of the side wall surface of the tire is not conspicuous is known (Japanese Laid-Open Patent Publication No. 2011-37388).

In a decorative portion that extends band-like in the circumferential direction on the outer surface of the pneumatic tire described above, a first ridge group and a second ridge group are formed each including a plurality of ridges disposed at a predetermined pitch extending in the tire radial direction. Each ridge of the first ridge group and each ridge of the second ridge group intersect forming a moire pattern, so the undulation on the side wall surface is not conspicuous.

However, when attempting to make the undulation inconspicuous on the side wall surface in a pneumatic tire, various techniques other than the technique described in the above patent document are available.

### SUMMARY

The present technology provides a pneumatic tire in which the undulation of the side wall surface is sufficiently inconspicuous.

An aspect of the present technology is a pneumatic tire having a side wall portion.

The pneumatic tire includes a tread portion, a bead portion, and a side wall portion having a pattern A that can be distinguished from a surrounding region due to undulation of the side wall surface or due to light reflection characteristics.

The pattern A has a first pattern element region R1 and a second pattern element region R2.

The first pattern element region R1 has a first demarcated section having four corners that include two pairs of corners that face each other, the first demarcated section including a pair of first reduced regions and a first primary region formed therein, each of the first reduced regions being a closed region and provided on a straight line L1 linking a pair of corners among the two pairs of corners and distinguished visibly from a surrounding region thereof, the first primary region being a region other than the pair of first reduced regions in the first demarcated section and distinguished visibly from the pair of first reduced regions.

The second pattern element region R2 has a second demarcated section having four corners that include two pairs of corners that face each other, the second demarcated section including a pair of second reduced regions and a second primary region formed therein, each of the pair of second reduced regions being a closed region and provided on a straight line L2 linking a pair of corners among the two pairs of corners in the second demarcated section and having unevenness or light reflection characteristics identical with the first primary region in the first pattern element region R1, and the second primary region being is a region other than the pair of second reduced regions in the second demarcated section and having unevenness or light reflection characteristics identical with the pair of first reduced regions in the first pattern element region R1.

The first pattern element region R1 and the second pattern element region R2 are alternately provided in the tire radial direction and in the tire circumferential direction so that the straight line L1 and the straight line L2 face the same direction.

When the pattern A is rendered as a pattern A1, the side wall portion has the pattern A1 and a pattern A2 that has a first pattern element region R1′ that includes the first reduced region and the first primary region formed in the first demarcated section in the same way as the pattern A1, and a second pattern element region R2′ that includes the second reduced region and the second primary region formed in the second demarcated section in the same way as the pattern A1; and the pattern A2 is preferably provided to be adjacent to the pattern A1 in the tire radial direction or in the tire circumferential direction so that the straight line L1 in the pattern A1 and a straight line L1′ that links one of the pairs of corners within the first demarcated section in the pattern A2 face in directions that intersect each other.

The first pattern element region R1′ in the pattern A2 preferably abuts the second pattern element region R2′ in the pattern A1 and the second pattern element region R2 in the pattern A2 preferably abuts the first pattern element region R1 in the pattern A1 at a boundary between the pattern A1 and the pattern A2.

A below-mentioned pattern B abutting the pattern A1 and the pattern A2 is preferably provided around the pattern A1 and the pattern A2.

In this case, the pattern B has a third pattern element region R3 and a fourth pattern element region R4.

The third pattern element region R3 has a third demarcated section having four corners that include two pairs of corners that face each other, and is formed so as to have, in the third demarcated section, unevenness or light reflection characteristics identical with the first primary region in the pattern A1.

The fourth pattern element region R4 has a fourth demarcated section having four corners that include two pairs of corners that face each other, and is formed so as to have, in the fourth demarcated section, unevenness or light reflection characteristics identical with the second primary region in the pattern A1.

The third pattern element region R3 is provided so as to abut the second pattern element region R2 or R2′ in the tire radial direction and in the tire circumferential direction at the boundary between the pattern B and either one of the pattern A1 and the pattern A2.

Moreover, the fourth pattern element region R4 is provided so as to abut the first pattern element region R1 or R1′ in the tire radial direction and in the tire circumferential direction at the boundary between the pattern B and either one of the pattern A1 and the pattern A2.

The third pattern element region R3 and the fourth pattern element region R4 are alternately provided in the tire radial direction and in the tire circumferential direction.

Moreover, the side wall portion preferably has a joined pattern in which a combined pattern formed by the pattern A1 and the pattern A2 abutting each other, and an inverted pattern obtained by inverting the combined pattern 180 degrees around an end point on the boundary line between the pattern A1 and the pattern A2, are combined and joined.

At this time, the below-mentioned pattern B abutting the joined pattern is preferably provided around the joined pattern.

In this case, the pattern B has the third pattern element region R3 and the fourth pattern element region R4.

The third pattern element region R3 is formed so as to have the third demarcated section having four corners that include two pairs of corners that face each other, and to have, in the third demarcated section, unevenness or light reflection characteristics identical with the first primary region in the pattern A1.

The fourth pattern element region R4 is formed so as to have the fourth demarcated section having four corners that include two pairs of corners that face each other, and to have, in the fourth demarcated section, unevenness or light reflection characteristics identical with the second primary region in the pattern A1.

The third pattern element region R3 is provided so as to abut the second pattern element region R2 or R2′ in the joined pattern in the tire radial direction and in the tire circumferential direction at the boundary between the joined pattern and the pattern B.

Moreover, the fourth pattern element region R4 is provided so as to abut the first pattern element region R1 or R1′ in the joined pattern in the tire radial direction and in the tire circumferential direction at the boundary between the joined pattern and the pattern B.

The third pattern element region R3 and the fourth pattern element region R4 are alternately provided in the tire radial direction and in the tire circumferential direction.

A below-mentioned cross-shaped pattern A3 is preferably provided between the pattern A1 and the pattern A2 so as to extend linearly in the tire circumferential direction and in the tire radial direction.

In this case, the pattern A3 has a fifth pattern element region R5, a sixth pattern element region R6, and a seventh pattern element region R7.

The fifth pattern element region R5 has a fifth demarcated section having four corners that include two pairs of corners that face each other, the fifth demarcated section including a pair of third reduced regions and a fifth primary region formed therein, each of the pair of third reduced regions in the fifth demarcated section being a closed region and provided around two corners along the sides of the fifth demarcated section and having unevenness and light reflection characteristics identical with the first reduced region in the pattern A1, the fifth primary region being a region other than the pair of third reduced region in the fifth demarcated section and having unevenness and light reflection characteristics identical with the first primary region in the pattern A1.

The sixth pattern element region R6 has a sixth demarcated section having four corners that include two pairs of corners that face each other, the sixth demarcated section including a pair of fourth reduced regions and a sixth primary region, each of the pair of four reduced regions in the sixth demarcated section being a closed region provided around two corners along a side of the sixth demarcated section and having unevenness or light reflection characteristics identical with the first primary region of the first pattern element region in the pattern A1, the sixth primary region being a region other than the pair of fourth reduced regions in the sixth demarcated section and having unevenness or light reflection characteristics identical with the pair of first reduced regions in the first pattern element region in the pattern A1.

The seventh pattern element region R7 has a seventh demarcated section having four corners that include two pairs of corners that face each other, the seventh demarcated section including fifth reduced regions and a seventh primary region formed therein, each of the fifth reduced regions in the seventh demarcated section being a closed region around two pairs of corners in the seventh demarcated section and distinguished visibly from a surrounding region thereof, the seventh primary region being a region other than the fifth reduced region in the seventh demarcated section and distinguished visibly from the fifth reduced region.

The pattern A3 is formed so that the fifth pattern element region R5 and the sixth pattern element region R6 are alternately disposed in a line in one direction from a position of the seventh pattern element region R7 as a starting point.

The below-mentioned pattern B abutting the pattern A is preferably provided around the pattern A.

The pattern B has the third pattern element region R3 and the fourth pattern element region R4.

The third pattern element region R3 has the third demarcated section having the four corners that include the two pairs of corners that face each other, and is formed so as to have, in the third demarcated section, unevenness or light reflection characteristics identical with the first primary region in the pattern A.

The fourth pattern element region R4 has the fourth demarcated section having the four corners that include the two pairs of corners that face each other, and is formed so as to have, in the fourth demarcated section, unevenness or light reflection characteristics identical with the second primary region in the pattern A.

The third pattern element region R3 is provided so as to abut the second pattern element region R2 in the tire radial direction and in the tire circumferential direction at the boundary between the pattern A and the pattern B.

Moreover, the fourth pattern element region R4 is provided so as to abut the first pattern element region R1 in the tire radial direction and in the tire circumferential direction at the boundary between the pattern A and the pattern B.

The third pattern element region R3 and the fourth pattern element region R4 are alternately provided in the tire radial direction and in the tire circumferential direction.

The pattern B that abuts the pattern A1 and the pattern A2 is preferably provided around the pattern A1 and the pattern A2.

In this case, the pattern B has the third pattern element region R3 and the fourth pattern element region R4.

The third pattern element region R3 has the third demarcated section having the four corners that include the two pairs of corners that face each other, and is formed so as to have, in the third demarcated section, unevenness or light reflection characteristics identical with the first primary region.

The fourth pattern element region R4 has the fourth demarcated section having the four corners that include the two pairs of corners that face each other, and is formed so as to have, in the fourth demarcated section, unevenness or light reflection characteristics identical with the second primary region.

The third pattern element region R3 is provided so as to abut the second pattern element region R2 or R2′ in the tire radial direction and in the tire circumferential direction at the boundary between the pattern B and either one of the pattern A1 and the pattern A2.

Moreover, the fourth pattern element region R4 is provided so as to abut the first pattern element region R1 or R1′ in the tire radial direction and in the tire circumferential direction at the boundary between the pattern A and the pattern B.

The third pattern element region R3 and the fourth pattern element region R4 are alternately provided in the tire radial direction and in the tire circumferential direction.

Widths in the tire circumferential direction of the first pattern element region R1 and the second pattern element region R2 are preferably reduced as alternate arrangement of the first pattern element region R1 and the second pattern element region R2 along the tire circumferential direction is repeated.

Further, the pattern A is provided on at least two positions, for example, in the tire radial direction. In this case, the position of the pattern A in the tire circumferential direction is preferably shifted in the tire circumferential direction to be between adjacent patterns A in the tire radial direction.

The width of the pattern A in the tire circumferential direction is, for example, 20 mm or more and 70 mm or less.

The first primary region and the second reduced regions are preferably protruding from or recessed in the side wall surface with respect to the second primary region and the first reduced regions.

Alternatively, the surfaces of the first primary region, the second reduced regions, the second primary region, and the first reduced regions are preferably formed with a plurality of ridges that extend in one direction, and the first primary region and the second reduced regions in the first pattern element region are preferably provided with different light reflection characteristics than the second primary region and the first reduced regions by making the density of the ridges different.

According to the pneumatic tire of the present technology, it is possible to make the undulation of the side wall surface sufficiently inconspicuous.

### BRIEF DESCRIPTION OF THE DRAWINGS

FIG. 1 illustrates the surface of a side wall portion of a pneumatic tire according to a first embodiment.

FIG. 2 is a meridian cross-sectional view illustrating a portion of the pneumatic tire according to the first embodiment.

FIG. 3 is an explanatory view of the overlap in the carcass member which is the cause of the undulation that appears on the side wall surface of the tire.

FIGS. 4A and 4B are explanatory views of examples of the pattern formed in the side wall surface of the pneumatic tire according to the first embodiment.

FIGS. 5A to 5D are views illustrating cross-sections of the first pattern element region and the second pattern element region.

FIGS. 6A and 6B are explanatory views of very small unevenness formed in the first primary region and the second primary region.

FIGS. 7A to 7C are explanatory views of examples of the pattern formed in the side wall surface of the pneumatic tire according to the second embodiment.

FIGS. 8A to 8C are explanatory views of examples of the pattern formed in the side wall surface of the pneumatic tire according to the third embodiment.

FIGS. 9A to 9C are explanatory views of another example of the pattern depicted in FIG. 8.

FIGS. 10A and 10B are explanatory views of another example of the pattern depicted in FIG. 8.

FIG. 11 is a view of the pattern depicted in FIG. 10A depicted on the surface of the side wall portion of the pneumatic tire.

FIGS. 12A to 12E are explanatory views of another example of the pattern depicted in FIG. 10.

FIGS. 13A and 13B are explanatory views of examples of the pattern formed in the side wall surface of the pneumatic tire according to the fourth embodiment.

FIG. 14 is an explanatory view of another example of the pattern depicted in FIG. 13.

FIG. 15 is an explanatory view of another example of the pattern depicted in FIG. 13.

### DETAILED DESCRIPTION

The following is a detailed description of the pneumatic tire according to the present technology. In the following, the tire circumferential direction refers to the rolling direction of the tread portion when the tread portion is rotated about the tire rotational axis, and the tire radial direction refers to the direction that extends radiating from the tire rotational axis.

### First Embodiment

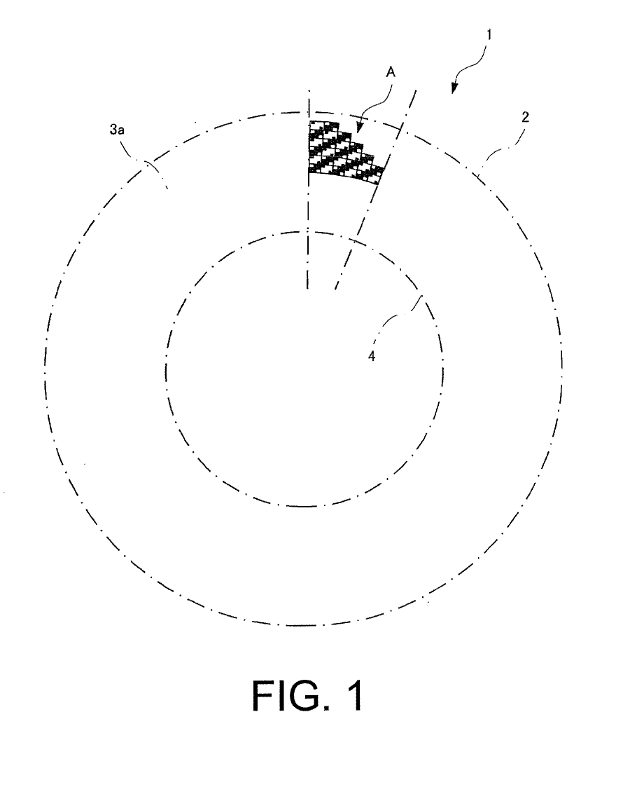

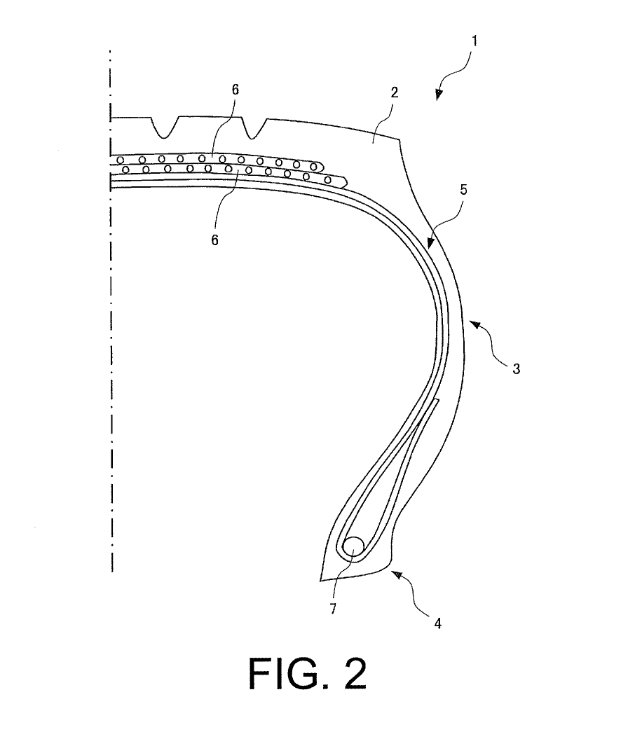

FIG. 1 illustrates the surface of a side wall portion 3 (see FIG. 2) of a pneumatic tire (hereinafter, referred to as tire) 1 according to a first embodiment. In FIG. 1, a tread portion 2 is shown as a circular arc chain dotted line, and a bead portion 4 is shown as a circular arc chain dotted line.

As illustrated in FIG. 2, the tire 1 includes the tread portion 2, the side wall portion 3, the bead portion 4, a carcass layer 5, and a belt layer 6. FIG. 2 is a meridian cross-sectional view illustrating a portion of the tire 1. In addition, the tire 1 includes an inner liner layer, and the like, that are not illustrated in the drawings. The side wall portion 3 and the bead portion 4 having a bead core 7 are formed as pairs that are disposed on both sides in the tire width direction so as to interpose the tread portion 2 therebetween.

As illustrated in FIG. 1, the side wall portion 3 includes a side pattern display area 3a, and an emblem display area (not illustrated in the drawings) provided on the tire circumference. In the emblem display area, the tire product name, brand name, tire manufacturer's name, size, and the like are displayed as characters, symbols, or numerals, or similar. The side pattern display area 3a is provided surrounding the emblem display area. The side pattern display area 3a in the following explanation may be provided in one of the side wall portions 3 in the width direction of the tire 1, or may be provided in the side wall portions 3 on both sides in the width direction of the tire 1.

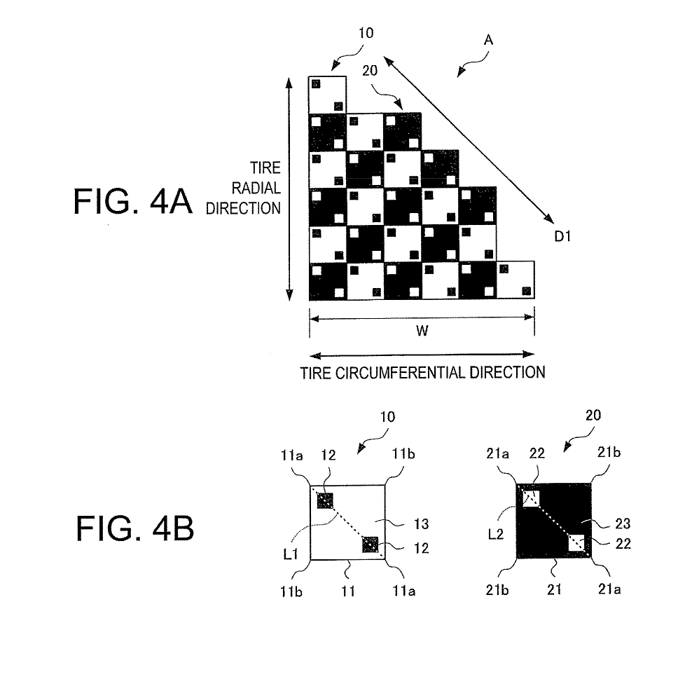

The side pattern display area 3a on the side wall surface has a pattern A that is visibly distinguished from a surrounding region due to undulation of the side wall surface or due to light reflection characteristics. The pattern A has a plurality of first pattern element regions 10 (first pattern element region R1) and a plurality of second pattern element regions 20 (see FIGS. 4A and 4B: second pattern element region R2), and the pattern A is formed by the first pattern element regions 10 and the second pattern element regions 20 being alternately arranged in the tire radial direction and in the tire circumferential direction.

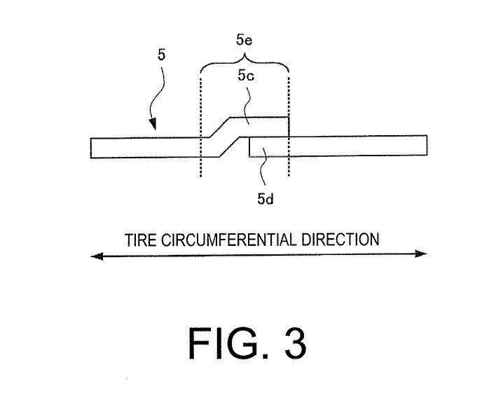

By providing the pattern A in this way, undulation appearing on the side wall surface is rendered inconspicuous when a person looking at the tire 1 sees a three-dimensional optical illusion due to the pattern A. The undulation appearing on the side wall surface is formed due to, for example, the possibility of a step being present in the tire radial direction due to a winding finishing end 5c and a winding starting end 5d of the carcass layer 5 overlapping at a portion 5e as illustrated in FIG. 3.

Next, a detailed explanation of the pattern A will be provided with reference to FIG. 4. FIGS. 4A and 4B are explanatory views of examples of the pattern A formed on the side wall surface.

As illustrated in FIG. 4A, the pattern A is formed due to the first pattern element region 10 and the second pattern element regions 20 being provided so as to spread in a substantially fan-like shape in the tire radial direction and in the tire circumferential direction using one first pattern element region 10 or one second pattern element region 20 as a starting point, as in the example illustrated in FIG. 4A which uses the second pattern element region 20 as the starting point. The shape in a plan view of the pattern A is not limited to a substantially fan-like shape and may be a substantially polygon shape such as a substantially triangular or substantially rectangular shape, or a substantially circular shape. The plan view in this case signifies looking at an object from the normal direction of the surface of the object. The number of the first pattern element regions 10 and second pattern element regions 20 that configure the pattern A is preferably three or more in total for each.

The width W in the tire circumferential direction of the pattern A is preferably, for example, 20 mm or more to 70 mm or less in order to render the undulation having a width of about 4 to 5 mm actually caused by the overlapping portion 5e of the carcass layer 5 inconspicuous.

As illustrated in FIG. 4B, the first pattern element region 10 that configures the pattern A has a first demarcated section 11 having four corners. While the shape in the plan view of the first pattern element region 10 according to the present embodiment is square as depicted in FIG. 4B, the first pattern element region 10 may assume other quadrilateral shapes such as a rectangular shape, a parallelogram, or a diamond shape. The corners are portions formed at the intersection of a line that stretches in the tire radial direction and a line that stretches in the tire circumferential direction. The two lines may be straight lines or may be curved lines. Moreover, one of the lines may be a straight line while the other of the two lines may be a curved line. The four corners of the first demarcated section 11 include two pairs of first corners 11a and a pair of first corners 11b. The two corners that configure the pair of first corners 11a among the two pairs of first corners 11a and 11b face each other, and the two corners that configure the other pair of first corners 11b also face each other.

A pair of first reduced regions 12 and a first primary region 13 are formed inside the first demarcated section 11. The pair of first reduced regions 12 are closed regions that are each provided on a straight line (diagonal line) L1 that links the two corners that configure the pair of first corners 11a, and are formed so as to be visibly distinguished from the surrounding region. The shape in the plan view of the pair of first reduced regions 12 may be square as depicted in FIG. 4B, or may be circular, oval, or a rectangular shape. The sizes of the pair of first reduced regions 12 may be the same or may be different. Moreover, one of the reduced regions among the pair of first reduced regions 12 is provided near or in contact with one of the corners among the pair of first corners 11a, and the other reduced region among the pair of first reduced regions is provided near or in contact with the other corner among the pair of first corners 11a. The distance between a portion of the first reduced region 12 nearest the first corner 11a and the first corner 11a itself is preferably 10% or less of the length of the straight line L1. Moreover, the sizes of the regions of the pair of first reduced regions 12 are preferably 1/32 or more to ⅛ or less of the size of the first demarcated section 11.

The first primary region 13 is a region other than the pair of first reduced regions 12 within the first demarcated section 11, and is formed so as to be visibly distinguished from the pair of first reduced regions 12.

The second pattern element region 20 that configures the pattern A has a second demarcated section 21 having four corners in the same way as the first pattern element region 10. The four corners in the second demarcated section 21 include two pairs of second corners 21a and 21b. Two corners that configure one of the pair of second corners 21a among the two pairs of second corners 21a and 21b face each other, and the other two corners that configure the pair of second corners 21b also face each other. The size and the shape in the plan view of the second pattern element region 20 are preferably the same as those of the first pattern element region 10.

A pair of second reduced regions 22 and a second primary region 23 are formed within the second demarcated section 21. The pair of second reduced regions 22 are closed regions that are provided on a straight line (diagonal line) L2 that links the two corners that configure the pair of second corners 21a, and are formed so as to have unevenness or light reflection characteristics identical with the first primary region 13 of the first pattern element region 10. The shapes in the plan view, the sizes, and the placement positions within the demarcated section of the pair of second reduced regions 22 are preferably the same as those of the pair of first reduced regions 12.

The second primary region 23 is a region other than the pair of second reduced regions 22 within the second demarcated section 21, and is formed to have unevenness or light reflection characteristics identical with the pair of first reduced regions 12.

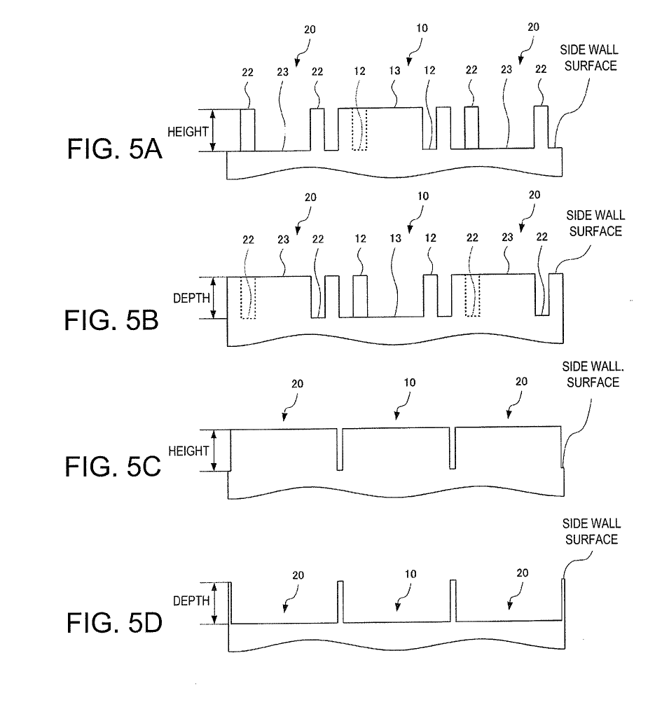

FIGS. 5A to 5D are views illustrating cross-sections of the first pattern element region 10 and the second pattern element region 20. In the examples illustrated in FIGS. 5A to 5D, the pattern A is made to be visibly distinguished from the surrounding region due to the surfaces of the first pattern element region 10 and the second pattern element region 20 having unevenness or having light reflection characteristics.

First, as illustrated in FIG. 5A, when a portion of the pattern A is formed by protrusions, the pair of reduced regions 12 of the first pattern element region 10 and the second primary region 23 of the second pattern element region 20 may be formed on the side wall surface, and the primary region 13 of the first pattern element region 10 and the pair of reduced regions 22 of the second pattern element region 20 may be provided so as to protrude from the side wall surface. Alternatively, when the primary region 13 of the first pattern element region 10 and the pair of reduced regions 22 of the second pattern element region 20 are formed on the side wall surface, the pair of reduced regions 12 of the first pattern element region 10 and the second primary region 23 of the second pattern element region 20 may be provided so as to protrude from the side wall surface.

Moreover, as illustrated in FIG. 5B, when portions of the pattern A are formed as grooves, the pair of reduced regions 12 of the first pattern element region 10 and the second primary region 23 of the second pattern element region 20 may be formed on the side wall surface, and the primary region 13 of the first pattern element region 10 and the pair of reduced regions 22 of the second pattern element region 20 may be provided so as to be recessed from the side wall surface. Alternatively, when the primary region 13 of the first pattern element region 10 and the pair of reduced regions 22 of the second pattern element region 20 are formed on the side wall surface, the pair of reduced regions 12 of the first pattern element region 10 and the second primary region 23 of the second pattern element region 20 may be provided so as to be recessed from the side wall surface.

Furthermore as illustrated in FIG. 5C, when the pattern A is formed as a convex shape, the boundary portions between the first pattern element region 10 and the second pattern element region 20 may be formed on the side wall surface, and the first pattern element region 10 and the second pattern element region 20 may be provided so as to protrude from the side wall surface.

Furthermore as illustrated in FIG. 5D, when the pattern A is formed as a concave shape, the boundary portions may be formed on the side wall surface, and the first pattern element region 10 and the second pattern element region 20 may be provided so as to be recessed from the side wall surface.

A below-mentioned serration process is performed on the surfaces of the first pattern element region 10 and the second pattern element region 20 in FIGS. 5C and 5D so that the pair of first reduced regions 12, the first primary region 13, the pair of second reduced regions 22, and the second primary region 23 are visibly distinguished from each other.

As illustrated in FIGS. 5A and 5B, the height or the depth of one or the other of the first primary region 13 and the second primary region 23 is preferably 0.3 mm to 3.0 mm in order to render the undulation present on the side wall surface inconspicuous by providing an effective optical illusion to a viewer.

The height with respect to the side wall surface of the first pattern element region 10 and the second pattern element region 20 when the pattern A is formed as a convex shape as illustrated in FIG. 5C, or the depth with respect to the side wall surface of the first pattern element region 10 and the second pattern element region 20 when the pattern A is formed as a concave shape as illustrated in FIG. 5D, is preferably 0.3 mm to 3.0 mm in order to render the undulation present on the side wall surface inconspicuous by providing an effective optical illusion to a viewer.

Moreover, when the first pattern element region 10 and the second pattern element region 20 that abut each other in the tire radial direction or in the tire circumferential direction are established as one set, the height or depth of one or the other of the first primary region 13 and the second primary region 23 in the set may be the same as or may be different from the height or the depth of one or the other of the first primary region 13 and the second primary region 23 in the other set. Further, the height or the depth with respect to the side wall surface of the first pattern element region 10 and the second pattern element region 20 may be the same or may be different.

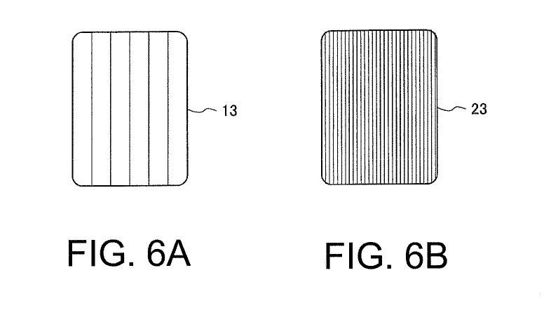

FIGS. 6A and 6B are explanatory views of preferable forms of the surfaces of the first primary region 13 and the second primary region 23. The surfaces of the pair of first reduced regions 12 are formed in the same way as the surface of the second primary region 23, and the surfaces of the pair of second reduced regions 22 are formed in the same way as the surface of the first primary region 13. Therefore, an explanation of the surfaces of the pair of first reduced regions 12 and the surfaces of the pair of second reduced regions 22 will be omitted.

The surfaces of the first primary region 13 and the second primary region 23 are preferably configured with very small unevenness due to a plurality of ridges disposed in one direction on the surfaces which are subject to the serration processing. The ridge densities of the serration processing are preferably different for the first primary region 13 and in the second primary region 23. For example, the density of the ridges in the second primary region 23 is greater than the density of the ridges in the first primary region 13. As a result, light incident on the surface of the second primary region 23 is subject to diffuse reflection or the degree of diffuse reflection is higher compared to the surrounding area. Therefore, the amount of light that is subject to diffuse reflection in the second primary region 23 and enters the field of vision of a viewer is less than the amount of light that reaches the viewer from the first primary region 13. As a result, the second primary region 23 appears darker compared to the first primary region 13 and thus is visibly distinguished from the first primary region 13 in an effective manner. In this case, the density of the ridges in the second primary region 23 is, for example, 1 ridge/mm to 2 ridges/mm, and the density of the ridges in the first primary region 13 is, for example, 0.4 ridges to 0.8 ridges/mm. The density of the ridges in the second primary region 23 is preferably, for example, double the density of the ridges in the first primary region 13 from the point of view of effectively providing an optical illusion for a viewer. The density of the ridges in the first primary region 13 may be higher than the density of the ridges in the second primary region 23.

Furthermore, the first primary region 13 and the second primary region 23 can be visibly distinguished from each other by a viewer by differentiation of at least one of the density of the ridges, the orientation of the ridges, or the width of the ridges thereof therebetween. Also, by providing a plurality of ridges, occurrence of air collection in the vulcanization process of the tire manufacturing stage is suppressed, so it is possible to reduce the rate of occurrence of appearance flaws.

The serration process is preferably performed on only one of the first primary region 13 and the second primary region 23 and the other region is preferably not subject to the serration processing and thus preferably has a smooth surface. Moreover, the serration processing may not be performed on the surface of both of the first primary region 13 and the second primary region 23.

While the pair of first reduced regions 12, the first primary region 13, the pair of second reduced regions 22, and the second primary region 23 are formed by providing surface undulation on the side wall surface in the present embodiment, a configuration without providing surface undulation on the side wall surface may also be used in which the pair of first reduced regions 12, the first primary region 13, the pair of second reduced regions 22, and the second primary region 23 are visibly distinguished due to the use of light reflection characteristics caused by differences due to different serration processing being performed. The use of reflection characteristics include using different reflection orientations, as well as using differences in reflection by diffuse reflection. For example, the pair of first reduced regions 12, the first primary region 13, the pair of second reduced regions 22, and the second primary region 23 are provided with smooth surfaces, and the orientations of the smooth surfaces are inclined to bring about differences between the pair of first reduced regions 12 and the second primary region 23, and between the first primary region 13 and the pair of second reduced regions 22.

The pattern A is formed as illustrated in FIG. 4A by the first pattern element region 10 and the second pattern element region 20 being arranged in the tire radial direction and in the tire circumferential direction alternately as described above. The first pattern element region 10 and the second pattern element region 20 in this case are provided so that the straight line L1 and the straight line L2 direct in the same direction (direction D1 in FIG. 4A).

In this case, since the first pattern element region 10 and the second pattern element region 20 both have the same size of square shape, the boundary line between adjacent rows in the tire radial direction, each row including the first pattern element region 10 and the second pattern element region 20 aligned in the tire circumferential direction, is a line that extends in the tire circumferential direction. Since the pair of first reduced regions 12 are provided in the first pattern element region 10 and the pair of second reduced regions 22 are provided in the second pattern element region 20, an optical illusion is provided to the viewer caused by the sense that the boundary line appears to be inclined (inclined to the right and downward in the example illustrated in FIG. 4A).

The boundary line between adjacent rows in the tire circumferential direction, each row including the first pattern element region 10 and the second pattern element region 20 aligned in the tire radial direction, is a line that extends in the tire radial direction. Since the pair of first reduced regions 12 are provided in the first pattern element region 10 and the pair of second reduced regions 22 are provided in the second pattern element region 20, an optical illusion is provided to the viewer caused by the sense that the boundary line appears to be inclined (inclined to the right and downward in the example illustrated in FIG. 4A).

As a result, any undulation that is actually present on the side wall surface can be rendered sufficiently inconspicuous to a viewer looking at the side wall surface of the tire 1 in the tire according to the present embodiment.

### Second Embodiment

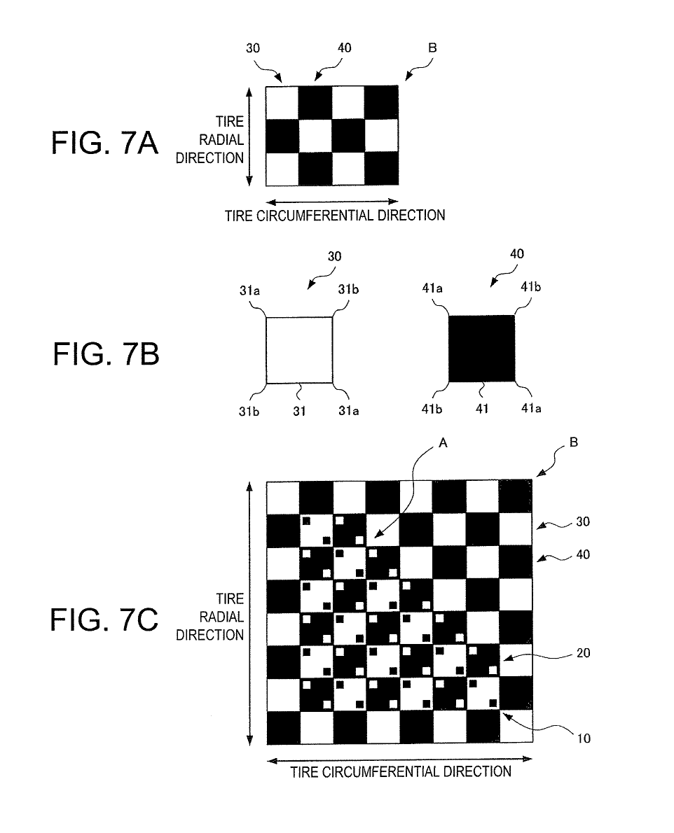

FIGS. 7A to 7C are explanatory views of an example of a pattern B formed on the side wall surface of the tire 1 according to a second embodiment.

The structure of the tire 1 according to the second embodiment is the same as the structure of the tire 1 according to the first embodiment as illustrated in FIG. 2. The difference between the tire 1 of the second embodiment and the tire 1 of the first embodiment is that the tire 1 of the second embodiment has the pattern B abutting the pattern A that is the same as that of the first embodiment and that the pattern B is provided around the pattern A.

A detailed explanation of the pattern B will be provided with reference to FIGS. 7A and 7B. The pattern B has a plurality of third pattern element regions 30 (third pattern element region R3) and a plurality of fourth pattern element regions 40 (see FIGS. 7A and 7B: fourth pattern element region R4), and the third pattern element regions 30 and the fourth pattern element regions 40 are provided in an alternating manner in the tire radial direction and in the tire circumferential direction. The provision of the pattern B in this way enables any undulation appearing in the side wall surface to be rendered further inconspicuous due to an improvement in the effect of the three-dimensional optical illusion of the pattern A that is made to stand out due to the pattern B.

As illustrated in FIG. 7B, the third pattern element region 30 that configures the pattern B has a third demarcated section 31 having four corners. The third pattern element region 30 is preferably formed to have the same shape in the plan view and the same size as the first pattern element region 10 and the second pattern element region 20. While the shape in the plan view of the third pattern element region 30 according to the present embodiment is square as depicted in FIG. 7B, the third pattern element region 30 may assume other quadrilateral shapes such as a rectangular shape, a parallelogram, or a diamond shape. The four corners of the third demarcated section 31 include two pairs of third corners 31a and a pair of third corners 31b. The two corners that configure a pair of third corners 31a among the two pairs of third corners 31a and 31b face each other, and the two corners that configure the other pair of third corners 31b also face each other.

The region inside the third demarcated section 31 is formed so as to have unevenness or light reflection characteristics identical with the first primary region 13 in the first pattern element region 10. More specifically, when the first primary region 13 of the first region 10 is formed so as to protrude from the side wall surface as depicted, for example, in FIG. 5A, the third demarcated section 31 is formed to protrude from the side wall surface in the same way as the first primary region 13. If the surface of the first primary region 13 is subject to the serration processing, the surface of the third demarcated section 31 is also subject to the serration processing to have the same density of the ridges, the same orientation of the ridges, or the same width of the ridges as that of the surface of the first primary region 13. That is, the region inside the third demarcated section 31 is formed to have unevenness or light reflection characteristics identical with the first primary region 13 based on the methods depicted in FIGS. 5A to 5D.

The fourth pattern element region 40 that configures the pattern B has a fourth demarcated section 41 having four corners. The four corners of the fourth demarcated section 41 include two pairs of fourth corners 41a and 41b. The two corners that configure a pair of fourth corners 41a among the two pairs of fourth corners 41a and 41b face each other, and the two corners that configure the other pair of fourth corners 41b also face each other. The fourth pattern element region 40 is preferably formed to have the same shape in the plan view and the same size as the first pattern element region 10, second pattern element region 20, and the third pattern element region 30.

The region inside the fourth demarcated section 41 is formed so as to have unevenness or light reflection characteristics identical with the second primary region 23 in the second pattern element region 20. More specifically, when the second primary region 23 in the second pattern element region 20 is formed so as to protrude from the side wall surface as illustrated, for example, in FIG. 5A, the fourth demarcated section 41 is formed so as to be recessed from the side wall surface in the same way as the second primary region 23 in the second pattern element region 20. If the surface of the second primary region 23 in the second pattern element region 20 is subject to the serration processing, the surface of the fourth demarcated section 41 is also subject to the serration processing to have the same density of the ridges, the same orientation of the ridges, or the same width of the ridges as that of the surface of the second primary region 23 in the second pattern element region 20. That is, the region inside the fourth demarcated section 41 is formed to have unevenness or light reflection characteristics identical with the second primary region 23 of the second pattern element region 20 based on the methods depicted in FIGS. 5A to 5D.

The pattern B is formed as illustrated in FIG. 7A by the third pattern element region 30 and the fourth pattern element region 40 being alternately arranged in the tire radial direction and in the tire circumferential direction as described above. As illustrated in FIG. 7C, the pattern B is provided around the pattern A so as to abut the pattern A.

The third pattern element region 30 of the pattern B is provided so as to abut, or more specifically so as to have line contact with, the second pattern element region 20 of the pattern A in the tire radial direction and in the tire circumferential direction at the boundary between the pattern A and the pattern B. The fourth pattern element region 40 of the pattern B is provided so as to abut the first pattern element region 10 of the pattern A in the tire radial direction and in the tire circumferential direction at the boundary between the pattern A and the pattern B.

In this case, since the first pattern element region 10, the second pattern element region 20, the third pattern element region 30, and the fourth pattern element region 40 all have a square shape of the same size, a boundary line between adjacent rows in the tire radial direction, each row including the first pattern element region 10, the second pattern element region 20, the third pattern element region 30, and the fourth pattern element region 40 aligned in the tire circumferential direction, forms a straight line that stretches in the tire circumferential direction. Since the pair of first reduced regions 12 are provided in the first pattern element region 10 and the pair of second reduced regions 22 are provided in the second pattern element region 20, a sense is developed that only a portion of the boundary line within the pattern A appears to be inclined (inclined to the right and downward in the example illustrated in FIG. 7C). As a result, a viewer is provided with a three-dimensional optical illusion as if the pattern A rises up from the pattern B. Therefore, any undulation appearing on the side wall surface is made to be less inconspicuous due to the improvement in the effect of the three-dimensional optical illusion of the pattern A that is made to stand out due to the pattern B in the tire 1 of the present embodiment.

### Third Embodiment

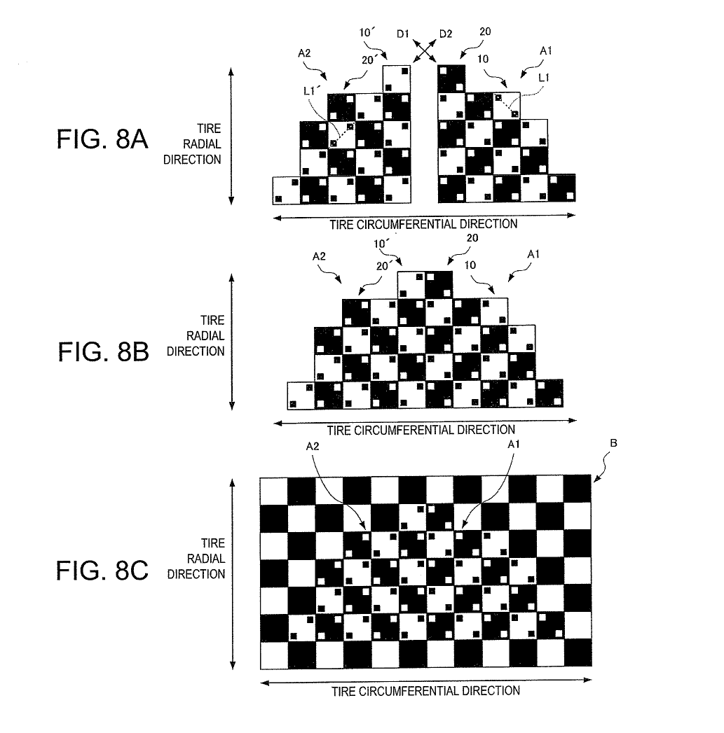

FIGS. 8A to 8C are explanatory views of an example of patterns formed on the side wall surface of the tire 1 according to a third embodiment.

The structure of the tire 1 according to the third embodiment is the same as the structure of the tire 1 according to the above embodiments. The difference between the tire 1 of the third embodiment and the tire 1 of the above embodiments is that, as illustrated in FIG. 8A, the pattern A of the first embodiment or of the second embodiment is referred to as a pattern A1, and the pattern A1 and a pattern A2 formed in the same way as the pattern A1 are provided on the side wall surface.

The pattern A2 has a plurality of first pattern element regions 10′ (first pattern element region R1′) and a plurality of second pattern element regions 20′ (second pattern element region R2′) as illustrated in FIG. 8A, and the pattern A2 is formed by the first pattern element regions 10′ and the second pattern element regions 20′ being alternately arranged in the tire radial direction and in the tire circumferential direction. By providing the pattern A2 in this way, any undulation appearing on the side wall surface can be rendered less conspicuous due to the improvement of the effect of the three-dimensional optical illusion achieved with the entire pattern when the pattern A1 and the pattern A2 are combined.

The pattern A2 is provided so as to be adjacent to the pattern A1 in the tire circumferential direction as illustrated in FIGS. 8A and 8B. The pattern A2 may be provided so as to be adjacent to the pattern A1 with a gap therebetween in the tire circumferential direction as illustrated in FIG. 8A, or may be provided so as to abut (line contact) the pattern A1 as illustrated in FIG. 8B. When the pattern A2 is provided so as to abut the pattern A1 as illustrated in FIG. 8B, the second pattern element regions 20′ in the pattern A2 are preferably provided so as to abut the first pattern element regions 10 in the pattern A1 along the boundary between the pattern A2 and the pattern A1, and the first pattern element regions 10′ in the pattern A2 are preferably provided so as to abut the second pattern element regions 20 in the pattern A1 in the tire circumferential direction along the boundary between the pattern A2 and the pattern A1.

The first pattern element region 10′ in the pattern A2 has the pair of first reduced regions 12 on a straight line L1′ that links a pair of corners. The second pattern element region 20′ in the pattern A2 has the pair of second reduced regions 22 on a straight line that directs in the same direction (D2 direction in FIG. 8A) as the straight line L1′ and that links a pair of corners. The first pattern element region 10′ and the second pattern element region 20′ are provided so that the direction that the straight line L1′ directs intersects with the direction (direction D1 in FIG. 8A) that the straight line L1 of the pattern A1 directs.

In this case, since the first pattern element region 10′ and the second pattern element region 20′ in the pattern A2 both have the same size of square shape as the first pattern element region 10 and the second pattern element region 20 in the pattern A1, the boundary line between adjacent rows in the tire radial direction, each row including the first pattern element region 10′ and the second pattern element region 20′ aligned in the tire circumferential direction, is a straight line that extends in the tire circumferential direction. Since the pair of first reduced regions 12 are provided in the first pattern element region 10′ and the pair of second reduced regions 22 are provided in the second pattern element region 20′, a sense is developed that the boundary line appears to be inclined (inclined to the right and upward in the example illustrated in FIG. 8A) in the tire radial direction.

Moreover, when the pattern A2 is provided so as to be adjacent to the pattern A1 in the tire circumferential direction, since the boundary line in the tire circumferential direction within the pattern A2 appears to be inclined right and upward, and the boundary line in the tire circumferential direction within the pattern A1 appears to be inclined right and downward, the entire pattern including the pattern A1 and the pattern A2 is provided with a three-dimensional optical illusion effect so that the pattern appears to bulge in the tire radial direction. As a result, any undulation that is actually present on the side wall surface can be rendered sufficiently inconspicuous to a viewer looking at the side wall surface of the tire 1 in the tire 1 according to the present embodiment.

As illustrated in FIG. 8C, the pattern B illustrated in FIG. 7A may be provided so as to abut the pattern A1 and the pattern A2 around the pattern A1 and the pattern A2. In this case, a three-dimensional optical illusion effect is achieved in which the entire pattern including the pattern A1 and the pattern A2 appears to rise up from the pattern B.

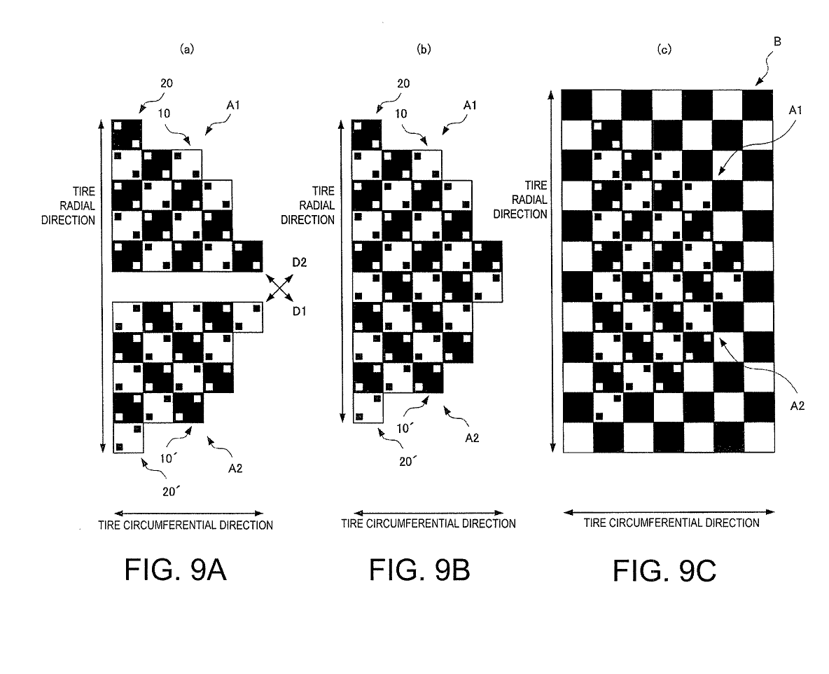

FIGS. 9A and 9C are explanatory views of another example of the pattern depicted in FIG. 8.

The pattern A2 is provided so as to be adjacent to the pattern A1 in the tire radial direction as illustrated in FIGS. 9A and 9B. The pattern A2 may be provided so as to be adjacent to the pattern A1 with a gap therebetween in the tire circumferential direction as illustrated in FIG. 9A, or may be provided so as to have line contact with the pattern A1 as illustrated in FIG. 9B. When the pattern A2 is provided so as to abut the pattern A1 as illustrated in FIG. 9B, the second pattern element regions 20′ in the pattern A2 are preferably provided so as to abut the first pattern element regions 10 in the pattern A1 along the boundary between the pattern A2 and the pattern A1, and the first pattern element regions 10′ in the pattern A2 are preferably provided so as to abut the second pattern element regions 20 in the pattern A1 in the tire radial direction along the boundary between the pattern A2 and the pattern A1.

Since the first pattern element region 10′ and the second pattern element region 20′ in the pattern A2 both have the same size of square shape, the boundary line between the first pattern element region 10′ and the second pattern element region 20′ aligned in a row in the tire radial direction and the first pattern element region 10′ and the second pattern element region 20′ aligned in a row in the tire radial direction and abutting the row in the tire circumferential direction, is a straight line that extends in the tire radial direction. Since the pair of first reduced regions 12 are provided in the first pattern element region 10′ and the pair of second reduced regions 22 are provided in the second pattern element region 20′, a sense is developed that the boundary line appears to be inclined (inclined to the left and downward in the example illustrated in FIG. 9A) in the tire circumferential direction.

Moreover, when the pattern A2 is provided so as to be adjacent to the pattern A1 in the tire radial direction, since the boundary line in the tire radial direction within the pattern A2 appears to be inclined left and downward while the boundary line in the tire circumferential direction within the pattern A1 appears to incline right and downward, the entire pattern including the pattern A1 and the pattern A2 is provided with a three-dimensional optical illusion effect so that the pattern appears to bulge in the tire circumferential direction.

As illustrated in FIG. 9C, the pattern B may be provided so as to abut the pattern A1 and the pattern A2 around the pattern A1 and the pattern A2. In this case, a three-dimensional optical illusion effect is achieved in which the entire pattern including the pattern A1 and the pattern A2 appears to rise up from the pattern B in the same way as the pattern illustrated in FIG. 7A.

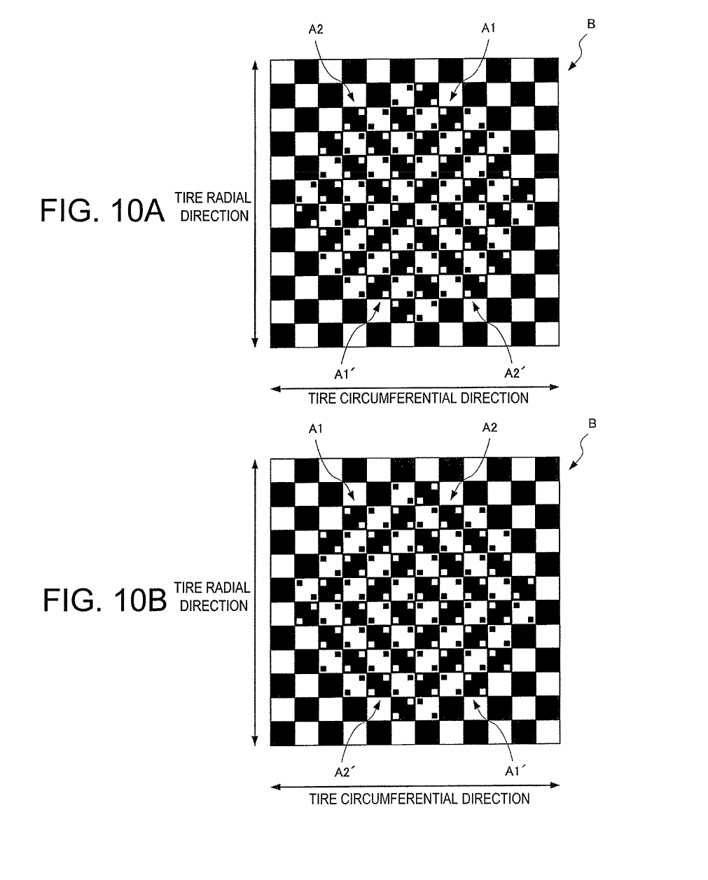

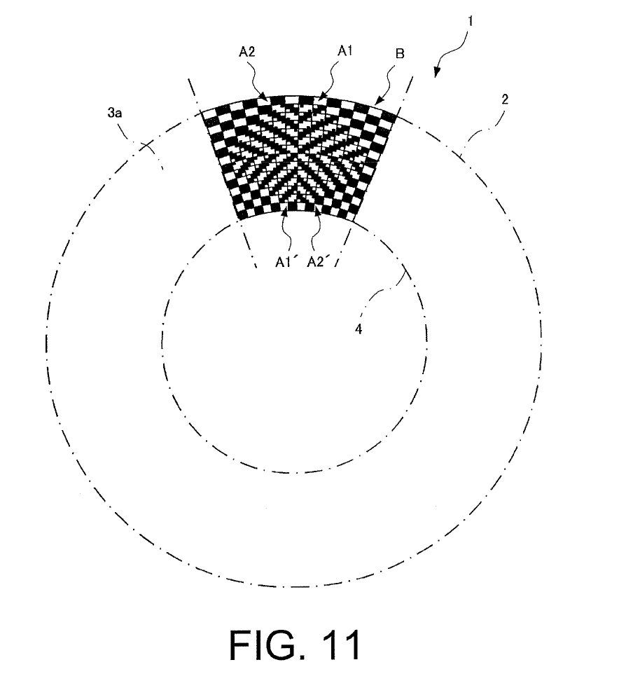

The following is an explanation of another example of the pattern illustrated in FIG. 8 with reference to FIGS. 10 and 11. FIGS. 10A and 10B are explanatory views of another example of the pattern depicted in FIG. 8. FIG. 11 is a view of the pattern depicted in FIG. 10A depicted on the surface of the side wall portion of the pneumatic tire.

As illustrated in FIGS. 10A and 11, the pattern A1, the pattern A2, a pattern A1′ and a pattern A2′ are provided so as to come into contact with each other on the side wall surface. That is, the side wall portion has a joined pattern in which a combined pattern formed by the pattern A1 and the pattern A2 abutting each other, and an inverted pattern obtained by inverting the combined pattern 180 degrees around an end point on the boundary line between the pattern A1 and the pattern A2, are combined and joined. The pattern B is provided in the same way as illustrated in FIG. 7A around the joined pattern configured with the above patterns. The pattern A1′ is configured in the same way as the pattern A1, and the pattern A2′ is configured in the same way as the pattern A2. The pattern A1 has line contact with the pattern A2 in the tire circumferential direction and has line contact with the pattern A2′ in the tire radial direction. The pattern A1′ has line contact with the pattern A2 and the pattern A2′ in the tire radial direction and in the tire circumferential direction respectively, and has a point contact with the pattern A1. The pattern A2 and the pattern A2′ have point contact.

In this case, the pair of first reduced regions 12 or the pair of second reduced regions 22 provided in each of the patterns A1, A2, A1′, and A2′ are provided so as to spread in a substantially annular manner in the tire circumferential direction and in the tire radial direction from the center point of a portion where the patterns A1, A2, A1′, and A2′ come into contact with each other. As a result, the entire pattern including the patterns A1, A2, A1′, and A2′ is provided with a three-dimensional optical illusion effect so that the entire pattern appears to bulge in the tire circumferential direction and in the tire radial direction.

As illustrated in FIG. 10B, when the dispositions of the pattern A1 and the pattern A2 are switched and the dispositions of the pattern A1′ and the pattern A2′ are switched, the pair of first reduced regions 12 or the pair of second reduced regions 22 provided in each of the patterns A1, A2, A1′, and A2′ are provided so as to spread in a substantially radial manner in the tire circumferential direction and in the tire radial direction from the center point of a portion where the patterns A1, A2, A1′, and A2′ come into contact with each other. As a result, the entire pattern including the patterns A1, A2, A1′, and A2′ is provided with a three-dimensional optical illusion effect so that the entire pattern appears to be recessed in the tire circumferential direction and in the tire radial direction.

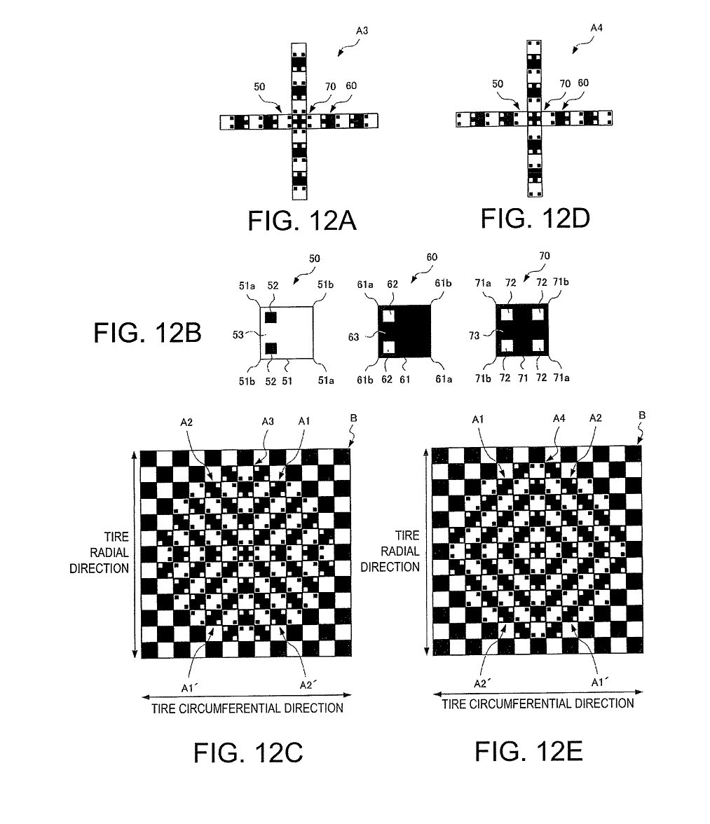

Next, other examples of the pattern illustrated in FIG. 10 are described with reference to FIG. 12. FIGS. 12A to 12E are explanatory views of another example of the pattern depicted in FIG. 10.

A pattern A3 illustrated in FIG. 12A may be provided on the side wall surface. The pattern A3 has a plurality of fifth pattern element regions 50 (fifth pattern element region R5), a plurality of sixth pattern element regions 60 (sixth pattern element region R6), and one seventh pattern element region 70 (seventh pattern element region R7), and the pattern A3 is formed so that the fifth pattern element regions 50 and the sixth pattern element regions 60 are alternately arranged in the tire circumferential direction and in the tire radial direction with the seventh pattern element region 70 as a starting point.

As illustrated in FIG. 12B, the fifth pattern element region 50 that configures the pattern A3 has a fifth demarcated section 51 having four corners. The fifth pattern element region 50 is preferably formed to have the same shape in the plan view and the same size as the first pattern element region 10 and the second pattern element region 20. The four corners in the fifth demarcated section 51 include two pairs of fifth corners 51a and 51b. The two corners that configure a pair of the fifth corners 51a among the two pairs of fifth corners 51a and 51b face each other, and the two corners that configure the other pair of fifth corners 51b also face each other.

A pair of third reduced regions 52 and a fifth primary region 53 are provided inside the fifth demarcated section 51. The pair of third reduced regions 52 are closed regions that are visibly distinguished from the surrounding region, and are formed to have unevenness or light reflection characteristics identical with the pair of first reduced regions 12. The unevenness or the light reflection characteristics are made with the same methods described in FIGS. 5A to 5D. One of the third reduced region 52 among the pair of third reduced regions 52 is provided near one corner among the two corners that configure of fifth corners 51a, and the other third reduced region 52 is provided near one corner among the two corners that configure the other pair of fifth corners 51b.

The fifth primary region 53 is a region other than the pair of fifth reduced regions 52 within the fifth demarcated section 51, and is formed to have unevenness or light reflection characteristics identical with the first primary region 13. The unevenness or the light reflection characteristics are made with the same methods described in FIGS. 5A to 5D.

The sixth pattern element region 60 that configures the pattern A3 has a sixth demarcated section 61 having four corners in the same way as the fifth pattern element region 50. The four corners of the sixth demarcated section 61 include two pairs of sixth corners 61a and 61b. Two corners that configure a pair of sixth corners 61a among the two pairs of sixth corners 61a and 61b face each other, and the two corners that configure the other pair of sixth corners 61b also face each other. The shape in the plan view and the size of the sixth pattern element region 60 is preferably the same as those of the fifth pattern element region 50 as illustrated in FIG. 12B.

A pair of fourth reduced regions 62 and a sixth primary region 63 are provided within the sixth demarcated section 61. The pair of fourth reduced regions 62 are closed regions that are visibly distinguished from the surrounding region, and are formed to have unevenness or light reflection characteristics identical with the pair of second reduced regions 22. The unevenness or the light reflection characteristics are made with the same methods described in FIGS. 5A to 5D. One of the fourth reduced region 62 among the pair of fourth reduced regions 62 is provided near one corner among the two corners that configure a pair of sixth corners 61a, and the other fourth reduced region 62 is provided near one corner among the two corners that configure the other pair of sixth corners 61b.

The sixth primary region 63 is a region other than the pair of fourth reduced regions 62 within the sixth demarcated section 61, and is formed to have unevenness or light reflection characteristics identical with the second primary region 23. The unevenness or the light reflection characteristics are made with the same methods described in FIGS. 5A to 5D.

Next, the seventh pattern element region 70 that configures the pattern A3 has a seventh demarcated section 71 having four corners in the same way as the fifth pattern element region 50 and the sixth pattern element region 60. The four corners of the seventh demarcated section 71 include two pairs of seventh corners 71a and 71b. The two corners that configure a pair of seventh corners 71a among the two pairs of seventh corners 71a and 71b face each other, and the two corners that configure the other pair of seventh corners 71b also face each other. The shape in the plan view and the size of the seventh pattern element region 70 is preferably the same those of the fifth pattern element region 50 and the sixth pattern element region 60 as illustrated in FIG. 12B.

The plurality of fifth reduced regions 72 and a seventh primary region 73 are provided within the seventh demarcated section 71. The plurality of fifth reduced regions 72 are closed regions that are visibly distinguished from the surrounding region, and are formed to have unevenness or light reflection characteristics identical with the pair of second reduced regions 22. The unevenness or the light reflection characteristics are made with the same methods described in FIGS. 5A to 5D. The plurality of fifth reduced regions 72 are provided near the two corners that configure a pair of sixth corners 71a, and are provided near the two corners that configure the other pair of sixth corners 71b.

The seventh primary region 73 is a region other than the plurality of fifth reduced regions 72 within the seventh demarcated section 71, and is formed to have unevenness or light reflection characteristics identical with the second primary region 23. The unevenness or the light reflection characteristics are made with the same methods described in FIGS. 5A to 5D.

The pattern A3 as illustrated in FIG. 12A is formed by alternately arranging the fifth pattern element region 50 and the sixth pattern element region 60 configured as described above in the tire radial direction and in the tire circumferential direction with the seventh pattern element region 70 as a starting point. The fifth pattern element region 50 and the sixth pattern element region 60 are provided so that the pair of third reduced regions 52 and the pair of fourth reduced regions 62 are disposed in positions near the seventh pattern element region 70. The fifth pattern element region 50 is provided so as to abut the seventh pattern element region 70 in the tire radial direction and in the tire circumferential direction.

The pattern A3 is provided between the patterns A1, A2, A1′, and A2′ described in FIG. 10A as illustrated in FIG. 12C. In this case, the pair of first reduced regions 12 or the pair of second reduced regions 22 provided in each of the patterns A1, A2, A1′, and A2′ are provided so as to spread in a substantially annular manner in the tire circumferential direction and in the tire radial direction with the seventh pattern element region 70 of the pattern A3 at the center. As a result, the entire pattern including the patterns A1, A2, A1′, and A2′ is provided with a three-dimensional optical illusion effect so that the entire pattern appears to bulge in the tire circumferential direction and in the tire radial direction.

A pattern A4 illustrated in FIG. 12D may be provided on the side wall surface. The pattern A4 has the plurality of fifth pattern element regions 50, the plurality of sixth pattern element regions 60, and one seventh pattern element region 70 in the same way as the pattern A3, and the pattern A4 is formed so that the fifth pattern element regions 50 and the sixth pattern element regions 60 are alternately arranged in the tire circumferential direction and in the tire radial direction with the seventh pattern element region 70 as a reference point. The fifth pattern element region 50 and the sixth pattern element region 60 are provided so that the pair of third reduced regions 52 and the pair of fourth reduced regions 62 are disposed in positions away from the seventh pattern element region 70. The fifth pattern element region 50 is provided so as to abut the seventh pattern element region 70 in the tire radial direction and in the tire circumferential direction.

The pattern A4 is provided, as illustrated in FIG. 12E, between the patterns A1, A2, A1′, and A2′ described in FIG. 10B. In this case, the pair of first reduced regions 12 or the pair of second reduced regions 22 provided in each of the patterns A1, A2, A1′, and A2′ are provided so as to spread in a substantially radial manner in the tire circumferential direction and in the tire radial direction with the seventh pattern element region 70 of the pattern A3 at the center. As a result, the entire pattern including the patterns A1, A2, A1′, and A2′ is provided with a three-dimensional optical illusion effect so that the entire pattern appears to be recessed in the tire circumferential direction and in the tire radial direction.

The plurality of fifth reduced regions 72 in the seventh pattern element region 70 of the pattern A3 and of the pattern A4 may be formed to have unevenness or light reflection characteristics identical with the pair of first reduced regions 12. In this case, the seventh primary region 73 preferably is formed to have unevenness or light reflection characteristics identical with the first primary region 13. The unevenness or the light reflection characteristics are made with the same methods described in FIGS. 5A to 5D.

### Fourth Embodiment

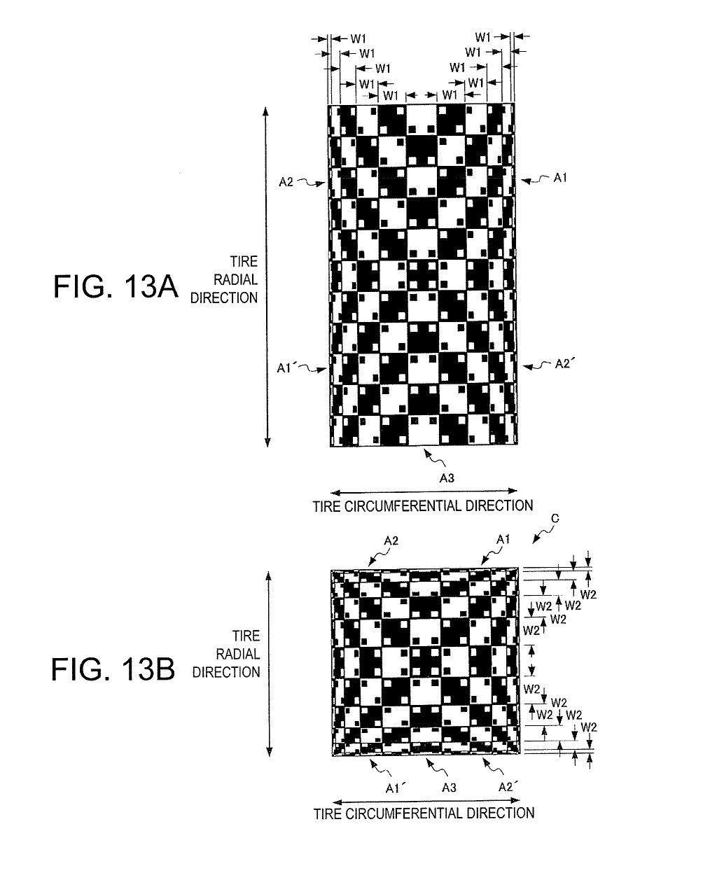

FIGS. 13A and 13B are explanatory views of examples of the pattern formed on the side wall surface of the pneumatic tire 1 according to a fourth embodiment.

The structure of the tire 1 according to the fourth embodiment is the same as the structure of the tire 1 according to the first embodiment as illustrated in FIG. 2. The difference between the tire 1 according to the fourth embodiment and the tire 1 according to the aforementioned embodiments is that a width W1 in the tire circumferential direction of the first pattern element regions 10 and 10′ and the second pattern element regions 20 and 20′ that configure the patterns becomes smaller as alternate arrangement of the regions are repeated in the tire circumferential direction.

As illustrated in FIG. 13A, a pattern that includes the patterns A1, A2, A1′, A2′, and A3 is provided on the side wall surface. In this pattern, the pair of first reduced regions 12 or the pair of second reduced regions 22 are provided so as to spread in a substantially annular manner in the tire circumferential direction and in the tire radial direction with the seventh pattern element region 70 of the pattern A3 at the center in the same way as the pattern illustrated in FIG. 12A. The width W1 in the tire circumferential direction of the first pattern element regions 10 and 10′ and of the second pattern element regions 20 and 20′ included respectively in the patterns A1, A2, A1′, and A2′, becomes smaller each time alternate arrangement of the first pattern element regions 10 and 10′ and the second pattern element regions 20 and 20′ is repeated away from the center in the tire circumferential direction of the pattern along the tire circumferential direction. The width W1 in the tire circumferential direction of the first pattern element regions 10 and 10′ and the second pattern element regions 20 and 20′ is preferably reduced by 20 to 50% of the width in the tire circumferential direction of a region (in the example illustrated in FIG. 13A, the fifth pattern element region 50, the sixth pattern element region 60, or the seventh pattern element region 70) in the center in the tire circumferential direction of the pattern, for example, for each of the first pattern element regions 10 and 10′ and the second pattern element regions 20 and 20′ arranged alternately in order to enable a viewer to see the three-dimensional optical illusion.

As a result, the pattern illustrated in FIG. 13A is provided with the effect of the three-dimensional optical illusion in which the center in the tire circumferential direction appears to rise up due to the provision of a sense of depth caused by the widths W1 in the tire circumferential direction of the first pattern element regions 10 and 10′ and the second pattern element regions 20 and 20′ at both ends in the tire circumferential direction becoming smaller.

As illustrated in FIG. 13B, a width W2 in the tire radial direction of the first pattern element region 10 and 10′ and the second pattern element region 20 and 20′ may be formed so as to become smaller each time alternate arrangement of the first pattern element regions 10 and 10′ and the second pattern element regions 20 and 20′ is repeated in the tire radial direction. In this case, the width W2 in the tire radial direction of the first pattern element regions 10 and 10′ and of the second pattern element regions 20 and 20′ preferably becomes smaller each time alternate arrangement of the first pattern element regions 10 and 10′ and the second pattern element regions 20 and 20′ is repeated away from the center in the tire circumferential direction of the pattern along the tire circumferential direction.

As a result, the pattern illustrated in FIG. 13B is provided with the effect of the three-dimensional optical illusion in which the center in the tire circumferential direction appears to rise up due to the provision of a sense of depth caused by the widths W1 in the tire circumferential direction of the first pattern element regions 10 and 10′ and the second pattern element regions 20 and 20′ at both ends in the tire radial direction becoming smaller.

In this way, a form in which the widths W1 in the tire circumferential direction or the widths W2 in the tire radial direction are gradually changed may be applied to the forms described in the first to third embodiments.

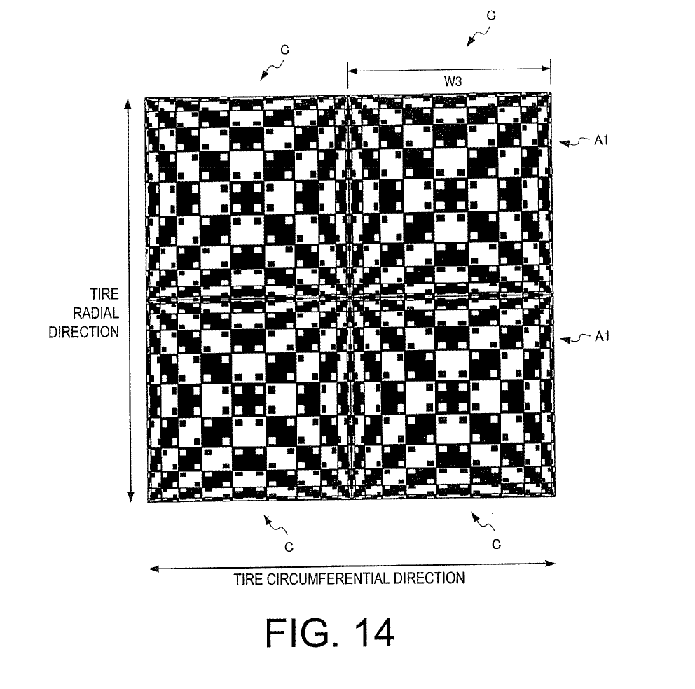

FIG. 14 is an explanatory view of another example of the pattern depicted in FIG. 13.

As illustrated in FIG. 14, when the pattern illustrated in FIG. 13B is established as a pattern C, the pattern C is preferably provided on at least two positions in the tire radial direction. That is, the pattern A1, which is the pattern A, included in the pattern C is preferably provided on at least two positions in the tire radial direction. A width W3 in the tire circumferential direction of the pattern C is preferably, for example, 20 mm or more to 70 mm or less in order to render the undulation having a width of about 4 to 5 mm actually caused by the overlapping portion 5e of the carcass layer 5 inconspicuous.

As a result, the undulation can be sufficiently rendered inconspicuous due to the continuous effect of the three-dimensional optical illusion provided in the tire radial direction, even if undulation stretching in the tire radial direction is formed on the side wall surface.

The pattern C is also preferably provided on at least two positions in the circumferential direction.

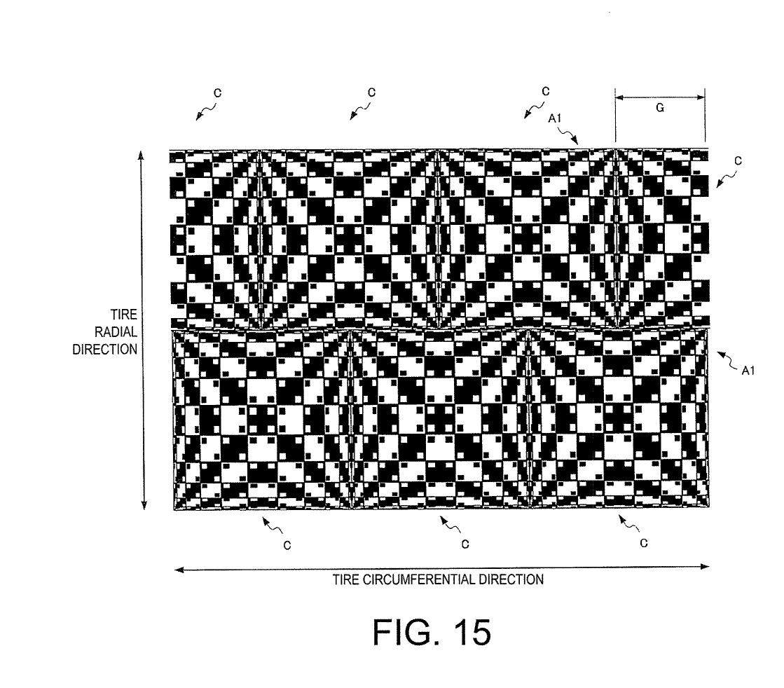

FIG. 15 is an explanatory view of another example of the pattern depicted in FIG. 13.

As illustrated in FIG. 15, positions of the pattern C in the tire circumferential direction are preferably shifted in the tire circumferential direction between adjacent patterns C in the tire radial direction when at least two patterns C are provided in both the tire radial direction and the tire circumferential direction. That is, the pattern A1, which is the pattern A, included in the pattern C has preferably position shift in the tire circumferential direction between the patterns A1 included in the pattern C adjacent to each other in the tire radial direction. A length G of the position shift in the tire circumferential direction between the patterns C, that is between the patterns A1, is preferably, for example, ¼ or more to ¾ or less the width in the tire circumferential direction of the pattern C or of the pattern A1 in order to render undulation present on the side wall surface inconspicuous.

### EXAMPLES

In order to examine the effects of the present embodiments, tires 1 (tire size: 145R126PR) illustrated in FIG. 2 were manufactured with various changes in the side patterns on the side wall surfaces. 100 people observed the manufactured tires and evaluated the visibility of undulation (herein referred to as BPS splice undulation) caused by overlapping portions 5e in carcass layers 5 illustrated in FIG. 3 that were actually present on the side wall surfaces.

The following scores were used for the evaluation results.
Score 110: 95% or more of the observers were unable to clearly recognize the BPS splice undulation.
Score 108: 90% or more and less than 95% of the observers were unable to clearly recognize the BPS splice undulation.
Score 106: 80% or more and less than 90% of the observers were unable to clearly recognize the BPS splice undulation.
Score 104: 70% or more and less than 80% of the observers were unable to clearly recognize the BPS splice undulation.
Score 102: 60% or more and less than 70% of the observers were unable to clearly recognize the BPS splice undulation.
Score 100: 50% or more and less than 60% of the observers were unable to clearly recognize the BPS splice undulation.
Score 98: less than 50% of the observers were unable to clearly recognize the BPS splice undulation.

The side wall surfaces used in the test and the evaluation results are shown in the following table.

The Comparative Example was a tire with no side pattern display area 3a. In the working example 1, the pattern A was provided in the side pattern display area 3a.

The tire in the working example 2 was formed so that the widths of the first pattern element region 10 and the second pattern element region 20 in the tire circumferential direction were smaller each time alternate arrangement of the first pattern element region 10 and the second pattern element region 20 was repeated in the tire circumferential direction.

A plurality of patterns A were provided in the tire radial direction in the working example 3.

Moreover, positions of patterns A adjacent to each other in the tire radial direction were shifted in the tire circumferential direction in the working example 4. The ratio of the length of position shift in the tire circumferential direction between patterns A adjacent to each other in the tire radial direction is represented with respect to width in the tire circumferential direction of the pattern A in the row entitled “Length of position shift in the tire circumferential direction between patterns A adjacent to each other in the tire radial direction/dimension in the tire circumferential direction of the pattern A” in the following table.

Furthermore, the dimension (width) in the tire circumferential direction of the pattern A is changed in the working examples 5 to 8. The arrow symbol in the table 1 signifies that the contents are the same as the contents described in the field to the immediate left of each field.

TABLE 1

| | Comparative | Working | Working | Working | Working |
|---|---|---|---|---|---|
| | Example | Example 1 | Example 2 | Example 3 | Example 4 |
| Presence of pattern A | None | Present | ← | ← | ← |
| Variation of the dimension in the tire | — | None | Present | ← | ← |
| circumferential direction of the first | | | | | |
| region and the second region | | | | | |
| Number of patterns A in the tire radial | — | 1 | ← | 2 | ← |
| direction | | | | | |
| Length of position shift in the tire | — | 0 | ← | ← | 0.5 |
| circumferential direction between | | | | | |
| patterns A adjacent to each other in | | | | | |
| the tire radial direction/dimension | | | | | |
| in the tire circumferential direction | | | | | |
| of the pattern A | | | | | |
| Dimension in tire circumferential | — | 19 | ← | ← | ← |
| direction of pattern A (mm) | | | | | |
| Appearance performance | 98 | 102 | 104 | 106 | 108 |

| | Working | Working | Working | Working |
|---|---|---|---|---|
| | Example 5 | Example 6 | Example 7 | Example 8 |
| Presence of pattern A | Present | ← | ← | ← |
| Variation of the dimension in the tire | Present | ← | ← | ← |
| circumferential direction of the first | | | | |
| region and the second region | | | | |
| Number of patterns A in the tire radial | 2 | ← | ← | ← |
| direction | | | | |
| Length of position shift in the tire | 0.5 | ← | ← | ← |
| circumferential direction between | | | | |
| patterns A adjacent to each other in | | | | |
| the tire radial direction/dimension | | | | |
| in the tire circumferential direction | | | | |
| of the pattern A | | | | |
| Dimension in tire circumferential | 20 | 45 | 70 | 71 |
| direction of pattern A (mm) | | | | |
| Appearance performance | 110 | 110 | 110 | 108 |

In comparing the comparative example and the working example 1, it can be seen that the evaluation results are improved due to the provision of the pattern A. This can be said to be due to the effect of the optical illusion of the pattern A that is configured by the first pattern element region 10 and the second pattern element region 20.

In comparing the working examples 1 and 2, it can be seen that the evaluation results are improved due to the widths of the first pattern element region 10 and the second pattern element region 20 in the tire circumferential direction being formed so as to become smaller each time alternate arrangement of the first pattern element region 10 and the second pattern element region 20 is repeated in the tire circumferential direction.

In comparing the working examples 2 and 3, it can be seen that the evaluation results are improved due to the provision of a plurality of patterns A in the tire radial direction.

Furthermore, in comparing the working examples 3 and 4, it can be seen that the evaluation results are improved due to the position shift in the tire circumferential direction of the patterns A adjacent to each other in the tire radial direction.

In comparing the working examples 4 to 8, it can be seen that the evaluation results are improved due to the width of the pattern A in the tire circumferential direction being set to 20 mm or more to 70 mm or less.

The pneumatic tire of the present technology was described in detail above. However, it should be understood that the present technology is not limited to the above embodiments, but may be improved or modified in various ways so long as these improvements or modifications remain within the scope of the present technology.

1. A pneumatic tire comprising:
a tread portion;
a bead portion; and
a side wall portion having a pattern A that is visibly distinguished from a surrounding region due to undulation of the side wall surface or due to light reflection characteristics; wherein
the pattern A has
a first pattern element region R1 having a first demarcated section having four corners that include two pairs of corners that face each other, the first demarcated section including a pair of first reduced regions and a first primary region formed therein, each of the first reduced regions being a closed region and provided on a straight line L1 linking a pair of corners among the two pairs of corners and distinguished visibly from a surrounding region thereof, the first primary region being a region other than the pair of first reduced regions in the first demarcated section and distinguished visibly from the pair of first reduced regions, and
a second pattern element region R2 having a second demarcated section having four corners that include two pairs of corners that face each other, the second demarcated section including a pair of second reduced regions and a second primary region formed therein, each of the pair of second reduced regions being a closed region and provided on a straight line L2 linking a pair of corners among the two pairs of corners in the second demarcated section and having unevenness or light reflection characteristics identical with the first primary region in the first pattern element region R1, and the second primary region being is a region other than the pair of second reduced regions in the second demarcated section and having unevenness or light reflection characteristics identical with the pair of first reduced regions in the first pattern element region R1; and
the first pattern element region R1 and the second pattern element region R2 are alternately provided in a tire radial direction and in a tire circumferential direction so that the straight line L1 and the straight line L2 face the same direction.

2. The pneumatic tire according to claim 1, wherein, when the pattern A is rendered as a pattern A1,
the side wall portion has the pattern A1 and a pattern A2 that has a first pattern element region R1′ that includes the first reduced region and the first primary region formed in the first demarcated section in the same way as the pattern A1, and a second pattern element region R2′ that includes the second reduced region and the second primary region formed in the second demarcated section in the same way as the pattern A1; and
the pattern A2 is provided to be adjacent to the pattern A1 in the tire radial direction or in the tire circumferential direction so that the straight line L1 in the pattern A1 and a straight line L1′ that links one of the pairs of corners to the first demarcated section in the pattern A2 face in directions that intersect each other.

3. The pneumatic tire according to claim 2, wherein, the first pattern element region R1′ in the pattern A2 abuts the first pattern element region R2′ in the pattern A1 at a boundary between the pattern A1 and the pattern A2, and the second pattern element region R2′ in the pattern A2 abuts the second pattern element region R1′ in the pattern A1.

4. The pneumatic tire according to claim 3, wherein, a pattern B that abuts the pattern A1 and the pattern A2 is provided around the pattern A1 and the pattern A2; and
the pattern B has
a third pattern element region R3 that has a third demarcated section having four corners that include two pairs of corners that face each other, and is formed so as to have, in the third demarcated section, unevenness or light reflection characteristics identical with the first primary region in the pattern A1, and
a fourth pattern element region R4 that has a fourth demarcated section having four corners that include two pairs of corners that face each other, and is formed so as to have, in the fourth demarcated section, unevenness or light reflection characteristics identical with the second primary region in the pattern A1,
wherein
the third pattern element region R3 is provided so as to abut the second pattern element region R2 or R2′ in the tire radial direction and in the tire circumferential direction at a boundary between the pattern B and either one of the pattern A1 and the pattern A2,
the fourth pattern element region R4 is provided so as to abut the first pattern element region R1 or R1′ in the tire radial direction and in the tire circumferential direction at a boundary between the pattern B and either one of the pattern A1 and the pattern A2; and
the third pattern element region R3 and the fourth pattern element region R4 are alternately provided in the tire radial direction and in the tire circumferential direction.

5. The pneumatic tire according to claim 3, wherein the side wall portion has a joined pattern in which a combined pattern formed by the pattern A1 and the pattern A2 abutting each other, and an inverted pattern obtained by inverting the combined pattern 180 degrees around an end point on a boundary line between the pattern A1 and the pattern A2, are combined and joined.

6. The pneumatic tire according to claim 5, wherein, a pattern B abutting the joined pattern is provided around the joined pattern, and
the pattern B has
a third pattern element region R3 that has a third demarcated section having four corners that include two pairs of corners that face each other, and is formed so as to have, in the third demarcated section, unevenness or light reflection characteristics identical with the first primary region in the pattern A1, and
a fourth pattern element region R4 that has a fourth demarcated section having four corners that include two pairs of corners that face each other, and is formed so as to have, in the fourth demarcated section, unevenness or light reflection characteristics identical with the second primary region in the pattern A1,
wherein
the third pattern element region R3 is provided so as to abut the second pattern element region R2 or R2′ in the joined pattern in the tire radial direction and in the tire circumferential direction at a boundary between the joined pattern and the pattern B,
the fourth pattern element region R4 is provided so as to abut the first pattern element region R1 or R1′ in the joined pattern in the tire radial direction and in the tire circumferential direction at a boundary between the joined pattern and the pattern B, and
the third pattern element region R3 and the fourth pattern element region R4 are alternately provided in the tire radial direction and in the tire circumferential direction.

7. The pneumatic tire according to claim 6, wherein, a cross-shaped pattern A3 is provided between the pattern A1 and the pattern A2 so as to extend linearly in the tire circumferential direction and the tire radial direction, and
the pattern A3 has:
a fifth pattern element region R5 having a fifth demarcated section having four corners that include two pairs of corners that face each other, the fifth demarcated section including a pair of third reduced regions and a fifth primary region formed therein, each of the pair of third reduced regions in the fifth demarcated section being a closed region and provided around two corners along the sides of the fifth demarcated section and having unevenness and light reflection characteristics identical with the first reduced region in the pattern A1, the fifth primary region being a region other than the pair of third reduced region in the fifth demarcated section and having unevenness and light reflection characteristics identical with the first primary region in the pattern A1;
a sixth pattern element region R6 having a sixth demarcated section having four corners that include two pairs of corners that face each other, the sixth demarcated section including a pair of fourth reduced regions and a sixth primary region, each of the pair of four reduced regions in the sixth demarcated section being a closed region provided around two corners along a side of the sixth demarcated section and having unevenness or light reflection characteristics identical with the first primary region of the first pattern element region in the pattern A1, the sixth primary region being a region other than the pair of fourth reduced regions in the sixth demarcated section and having unevenness or light reflection characteristics identical with the pair of first reduced regions in the first pattern element region in the pattern A1; and
a seventh pattern element region R7 having a seventh demarcated section having four corners that include two pairs of corners that face each other, the seventh demarcated section including fifth reduced regions and a seventh primary region formed therein, each of the pair of fifth reduced regions in the seventh demarcated section being a closed region around two pairs of corners in the seventh demarcated section and distinguished visibly from a surrounding region thereof, the seventh primary region being a region other than the fifth reduced region in the seventh demarcated section and distinguished visibly from the fifth reduced region
wherein the pattern A3 is formed so that the fifth pattern element region R5 and the sixth pattern element region R6 are alternately disposed in a line in one direction from a position of the seventh pattern element region R7.

8. The pneumatic tire according to claim 1, wherein, a pattern B abutting the pattern A is provided around the pattern A, and
the pattern B has
a third pattern element region R3 having a third demarcated section having four corners that include two pairs of corners that face each other, and formed so as to have, in the third demarcated section, unevenness or light reflection characteristics identical with the first primary region in the pattern A, and
a fourth pattern element region R4 having a fourth demarcated section having four corners that include two pairs of corners that face each other, and formed so as to have, in the fourth demarcated section, unevenness or light reflection characteristics identical with the second primary region in the pattern A,
wherein
the third pattern element region R3 is provided so as to abut the second pattern element region R2 in the tire radial direction and in the tire circumferential direction at a boundary between the pattern A and the pattern B,
the fourth pattern element region R4 is provided so as abut the first pattern element region R1 in the tire radial direction and in the tire circumferential direction at a boundary between the pattern A and the pattern B, and
the third pattern element region R3 and the fourth pattern element region R4 are alternately provided in the tire radial direction and in the tire circumferential direction.

9. The pneumatic tire according to claim 2, wherein, the pattern B that abuts the pattern A1 and the pattern A2 is provided around the pattern A1 and the pattern A2, and
the pattern B has
a third pattern element region R3 having a third demarcated section having four corners that include two pairs of corners that face each other, and is formed so as to have, in the third demarcated section, unevenness or light reflection characteristics identical with the first primary region, and
a fourth pattern element region R4 having a fourth demarcated section having four corners that include two pairs of corners that face each other, and formed so as to have, in the fourth demarcated section, unevenness or light reflection characteristics identical with the second primary region,
wherein
the third pattern element region R3 is provided so as to abut the second pattern element region R2 or R2′ in the tire radial direction and in the tire circumferential direction at a boundary between the pattern B and either one of the pattern A1 and the pattern A2,
the fourth pattern element region R4 is provided so as to abut the first pattern element region R1 or R1′ in the tire radial direction and in the tire circumferential direction at a boundary between the pattern A and the pattern B, and
the third pattern element region R3 and the fourth pattern element region R4 are alternately provided in the tire radial direction and in the tire circumferential direction.

10. The pneumatic tire according to claim 1, wherein, widths in the tire circumferential direction of the first pattern element region R1 and the second pattern element region R2 are reduced as alternate arrangement of the first pattern element region R1 and the second pattern element region R2 along the tire circumferential direction is repeated.

11. The pneumatic tire according to claim 1, wherein the pattern A is provided on at least two positions in the tire radial direction.

12. The pneumatic tire according to claim 11, wherein the positions of the pattern A are shifted each other in the tire circumferential direction between adjacent patterns A in the tire radial direction.

13. The pneumatic tire according to claim 1, wherein width of the pattern A in the tire circumferential direction is 20 mm or more to 70 mm or less.

14. The pneumatic tire according to claim 1, wherein the first primary region and the second reduced regions are protruding from or recessed in the side wall surface with respect to the second primary region and the first reduced regions.

15. The pneumatic tire according to claim 1, wherein surfaces of the first primary region, the second reduced regions, the second primary region, and the first reduced regions are formed with a plurality of ridges that extend in one direction, and
the first primary region in the first pattern element region and the second reduced regions have different light reflection characteristics from the second primary region and the first reduced regions by making a density of the ridges different from each other.
